(19) United States
(12) Patent Application Publication
(10) Pub. No.: US 2011/0007011 A1
(43) Pub. Date: Jan. 13, 2011

(54) CAPACITIVE TOUCH SCREEN WITH A MESH ELECTRODE

(75) Inventor: Larry Stephen Mozdzyn, Garland, TX (US)

Correspondence Address: MARTIN & ASSOCIATES, LLC, P O BOX 548, CARTHAGE, MO, 64836-0548, US

(73) Assignee: OCULAR LCD INC., Dallas, TX (US)

(21) Appl. No.: 12/824,167

(22) Filed: Jun. 26, 2010

Related U.S. Application Data
(60) Provisional application No. 61/224,999, filed on Jul. 13, 2009.

(51) Int. Cl. G06F 3/041

(52) U.S. Cl. 345/173

(57) ABSTRACT

An improved touch screen provides enhanced electrical performance and optical quality. The electrodes on the touch screen are made of a mesh of conductors to reduce the overall electrode resistance thereby increasing the electrical performance without sacrificing optical quality. The mesh electrodes comprise a mesh pattern of conductive material with each conductor comprising the mesh having a very small width such that the conductors are essentially invisible to the user of the touch screen.

### BACKGROUND

1. Technical Field

The disclosure and claims herein generally relate to touch screens, and more specifically relate to a touch screen having low resistance mesh electrodes to improve the electrical characteristics of the touch screen without compromising the optical characteristics.

2. Background Art

Touch screens have become an increasingly important input device. Touch screens use a variety of different touch detection mechanisms. One important type of touch screen is the capacitive touch screen. Capacitive touch screens are manufactured via a multi-step process. In a typical touch screen process, a transparent conductive coating, such as indium tin oxide (ITO) is formed into conductive traces or electrodes on two surfaces of glass. The conductive traces on the two surfaces of glass typically form a grid that can sense the change in capacitance when a user's finger or a pointer touches the screen near an intersection of the grid. Thus the capacitive touch screen consists of an array of capacitors, where a capacitor is created at each crossing of the x and y conductive traces or electrodes which are separated by a dielectric. These capacitors are charged and discharged by scanning electronics. The scanning frequency of the touch screen is limited by a resistance/capacitive (RC) time constant that is characteristic of the capacitors. As the resistance of the trace becomes larger and larger, scanning times become proportionately longer and longer. Longer scan times are even more problematic as the panel sizes get larger. The larger the panel size the longer the traces and the higher the resistance gets.

As mentioned above, in typical capacitive touch screens, the conductive traces or electrodes are formed with a layer of indium tin oxide (ITO). ITO is used because of its conductive and transparent qualities. However, the ITO traces are not completely transparent. The visibility of the electrode traces is distracting to the user. It is desirable for the touch screen to have the sense electrodes and other traces on the touch screen to be substantially invisible to the user, but it is also desirable to reduce the resistance of the traces to reduce the scan times and the performance of the touch screen. Increasing the thickness of the ITO layer can reduce the electrode trace resistance. However, increasing the thickness of the ITO layer sufficiently to decrease the electrode trace resistance results in reduced optical performance because the thicker ITO layer becomes more visible.

### BRIEF SUMMARY

The application and claims herein are directed to an improved touch screen with enhanced electrical performance and optical quality. The electrodes on the touch screen are made of a mesh of conductors to reduce the overall electrode resistance thereby increasing the electrical performance without sacrificing optical quality. The mesh electrodes comprise a mesh pattern of conductive material with each conductor comprising the mesh having a very small width such that the conductors are essentially invisible to the user of the touch screen.

The description and examples herein are directed to capacitive touch screens with two substrates for the conductive sense electrodes, but the claims herein expressly extend to other arrangements including a single glass or plastic substrate.

The foregoing and other features and advantages will be apparent from the following more particular description, and as illustrated in the accompanying drawings.

### BRIEF DESCRIPTION OF DRAWINGS

The disclosure will be described in conjunction with the appended drawings, where like designations denote like elements, and:

FIG. 1 is a cross-sectional side view of a capacitive touch screen according to the prior art;

FIG. 2 is a cross-sectional side view of a capacitive touch screen as described and claimed herein;

FIG. 3 shows a top view of mesh electrodes on a portion of the bottom glass of the touch screen shown in FIG. 2;

FIG. 4 shows an enlarged view of the cross section of the mesh electrode taken on the lines 4-4 of the touch screen shown in FIG. 3;

FIG. 5 shows an enlarged top view of the mesh conductors of the electrode shown in FIGS. 3 and 4;

FIG. 6 shows an example of mesh electrodes with a diamond shape pattern; and

FIG. 7 shows an example of mesh electrodes with stacked layers.

### DETAILED DESCRIPTION

As claimed herein, the electrodes on a touch screen are made of a mesh of conductors to reduce the overall electrode resistance thereby increasing the electrical performance without sacrificing optical quality. The mesh electrodes comprise a mesh pattern of conductive material with each conductor comprising the mesh having a very small width such that the conductors are essentially invisible to the user of the touch screen.

Touch Panel Transparency

The optical quality of a touch screen panel can be described in terms of transparency, where 100% transparent means 100% of the light transfers through the panel. A typical single layer of glass used in a touch screen panel has a transparency of about 97%. A typical optical adhesive has a transparency of about 99.5%. For a touch panel constructed out of two sheets of glass and a single layer of optical adhesive (No electrodes on the glass at all), the overall transparency of the panel can be calculated as follows:

Total Panel transparency=0.97*0.97*0.995=93.6%

As described in the background, a typical touch screen panel has a layer of ITO on the glass to form electrodes for sensing the location where the screen is touched. The transparency of ITO coated glass with 100 ohm/square ITO is ˜92%. A touch panel constructed out of 100 ohm ITO glass with the optical adhesive is therefore about 0.92*0.92*0.995=85%. Thinner layers of ITO can give a higher transparency, but as discussed above, it is advantageous to reduce the electrode resistance for better performance. Thus there is a tradeoff between transparency for better optical performance and resistance of the electrode for better touch performance.

In capacitive touch panels there are a different methodologies to measure the capacitive coupling effect when the panel is touched. Some methods use a separate sense line to sense the change in capacitance while the electrodes are being driven by the controller. In other methods, the electrodes are constantly being switched such that one electrode is driven and another electrode is used as the “sense” line. The touch panel described above does not show separate sense line. However, the mesh electrodes described herein can be used to reduce the resistance of touch panel structures, including sense lines and electrodes. The claims herein extend to any of these touch panel technologies whether using a separate sense line, or using electrodes that are doing double duty as electrodes and sense lines.

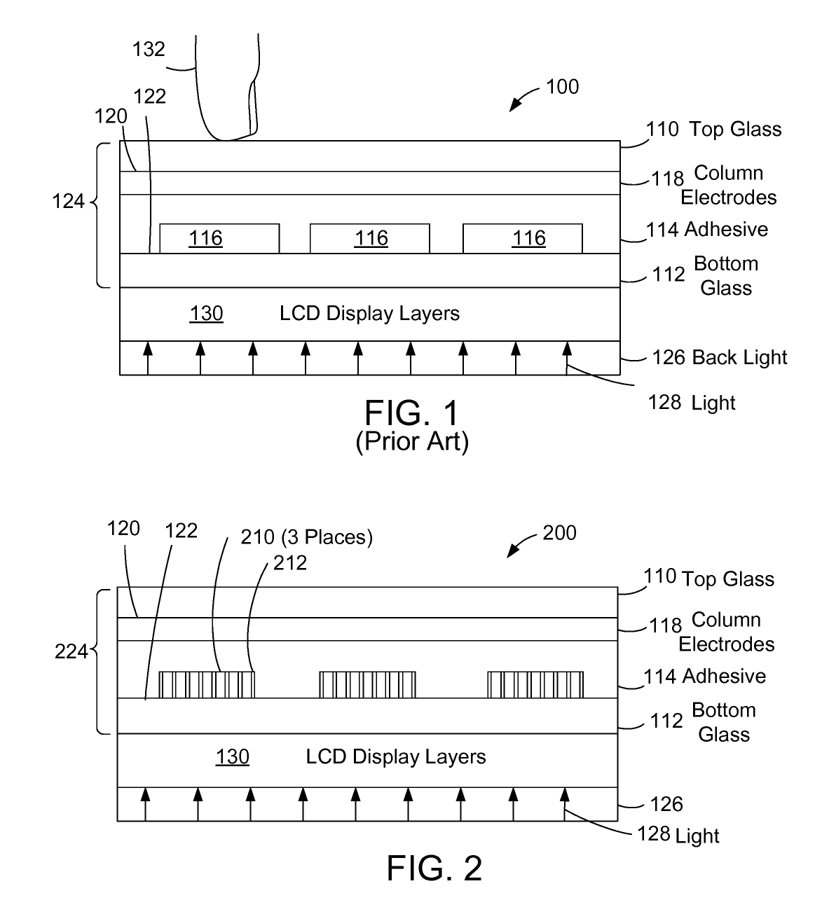

FIG. 1 shows a simplified side view of a capacitive touch screen 100 according to the prior art. The touch screen 100 has a top glass 110 and a bottom glass 112. The top glass 110 is bonded to the bottom glass 112 with a bonding layer or adhesive 114. Between the top glass and bottom glass there are row electrodes 116 and column electrodes 118. Only a single column electrode 118 is visible in this side view but there are multiple column electrodes such that the column electrode and the row electrodes form a grid in the manner known in the art. The column electrodes 118 are typically formed on the bottom surface 120 of the top glass 110 and the row electrodes 116 are formed on the top surface 122 of the bottom glass 112. The top glass 110 and bottom glass 112 attached by the adhesive layer 114 form a touch panel 124. Below the touch panel 124 is a back light 126 that provides light 128 to an LCD 130 that projects an image to the user through the touch panel 124. There may be a space (not shown) between the backlight 126 and the LCD 130. Sense electronics (not shown) connected to the row and column electrodes are able to determine the location of touch by a user's finger 132 in the manner known in the prior art.

FIG. 2 illustrates a cross sectional side view of a capacitive touch screen 200 as claimed herein. The touch screen panel 200 is similar to that shown in FIG. 1 with corresponding structures having the same number as described above. Instead of electrodes formed in an ITO layer as described above, the touch screen panel 224 has mesh electrodes 210 formed of low resistance conductors 212 to reduce the trace resistance of the electrode traces. As used herein, the term “mesh” means a light-transmissive layer of connected strands of opaque material. The mesh strands appears woven together similar to a web or net but are preferably formed in a layer of material rather than actually woven strands. The mesh electrodes 210 are thus an open pattern of low resistance conductors 212 that are electrically connected together to form an essentially transparent electrode. The mesh electrodes 210 are preferably formed directly on the bottom glass layer 112. The mesh electrodes 210 could be made from any suitable low resistance, opaque material such as nickel, copper, gold, silver, tin, aluminum and alloys and combinations of these metals. The mesh conductors 210 forming the mesh electrode could also be formed with a pattern to reduce visibility as described further below. The mesh conductors may be formed using methods such as pattern electrode plating, pattern electroless plating, plating followed by an etching process, thin film deposition followed by photo etching, or an other suitable method to produce the structures described herein whether known or developed in the future.

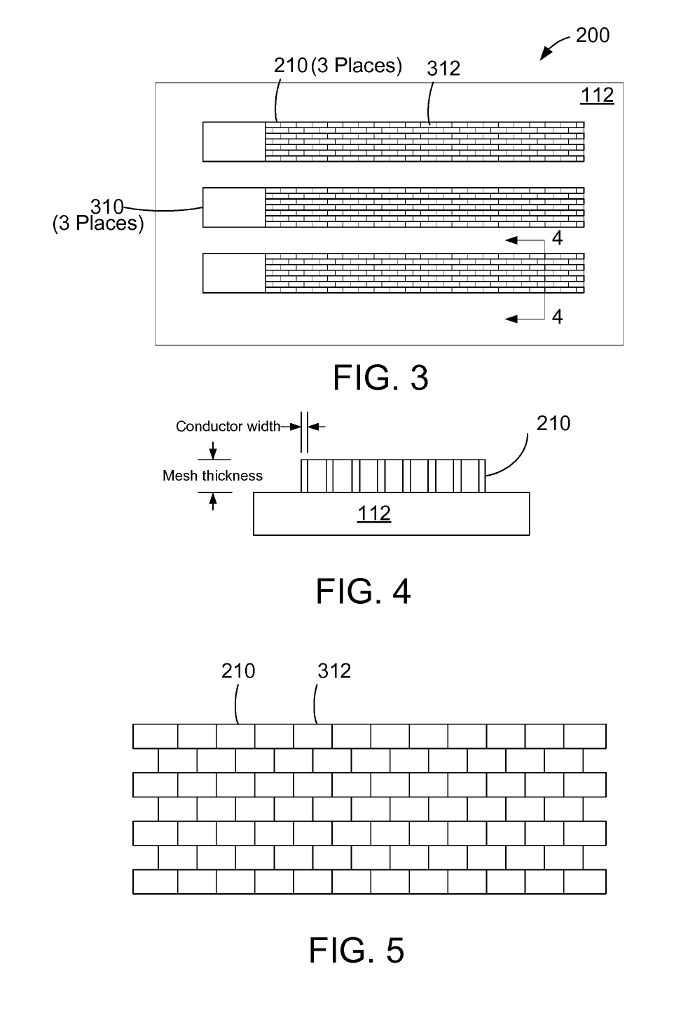

FIG. 3 shows a top view of mesh electrodes 210 on a portion of the bottom glass 112 of the touch screen 200 shown in FIG. 2. The mesh electrodes 210 each have a bonding pad 310 on one side of the electrode in the manner known in the prior art. FIG. 3 shows only a small number of electrodes of a touch panel as an example. A typical touch panel would have many such electrodes on the bottom glass 112. Similarly, a typical touch panel would have many column electrodes on the top glass orthogonal to the row electrodes in the manner known in the art. The column electrodes (shown in FIG. 2) are preferably also formed as mesh electrodes in the same manner as shown for row electrodes in FIG. 3. In this example, the mesh electrodes 210 have a mesh of metal conductors formed as a pattern of rectangles 312.

FIG. 4 shows an enlarged view of a cross section of the mesh electrode 210 on the bottom glass 112 taken on the lines 4-4 of touch screen 200 shown in FIG. 3. FIG. 5 shows an enlarged top view of the mesh conductors of the electrode shown in FIGS. 3 and 4. In FIG. 5, the mesh conductors 312 are more readily apparent as a pattern of rectangles 312. Preferably, the conductors of the mesh electrodes 210 have a small line geometry or trace width such that they are undetectable with the naked eye. The line geometries of the mesh conductors are preferably less than 0.025 millimeters (mm) in width and most preferably about 0.010 mm or less. Further, the overall percentage of area of the mesh electrodes conductors is substantially small compared to the total area of the mesh electrode to enhance the overall transparency of the electrodes such that the mesh electrode is essentially invisible to the naked eye. Preferably the percentage of the electrode area that comprises the mesh electrode conductors is less than 15% and more preferably 5% or less of the total area covered by the mesh electrode. This means that the surface area of the mesh electrode conductors 312, as seen from the top as shown in FIG. 3, covers 15% or less of the total area of the mesh electrode 210, also as seen from the top. The thickness of the conductors is not critical. A thicker mesh conductor material will lower the resistance of the electrode and improve performance as described above so a thicker mesh conductor is preferable depending on the geometries.

We will now consider how the mesh electrodes affect the resistance and optical clarity of a panel with mesh electrodes as shown in FIG. 4. In this example, we assume the mesh conductors 210 are 0.025 mm wide by 200 mm long by 0.001 mm thick nickel conductors. The equivalent transparency of the glass sheet with the mesh electrodes is a ratio of the open glass area to the mesh conductor area. The opaque mesh conductors cover about 4.0% of the electrode area, thus reducing the transparency of the area of the glass with mesh electrodes by about 4.0% (from 0.97 to about 0.93). In the non-trace area of the panel the transparency would remain at the glass transparency value of 97%. We assume the mesh electrodes cover about 30% of the overall glass area leaving about 70% of the area not covered by electrodes. Thus, the overall effective transparency to the single sheet of glass with mesh electrodes would be 0.97*0.7+0.93*0.3=96%. This would result in an overall panel transparency of 0.96*0.96*0.995=91% (two sheets of glass with mesh electrodes and adhesive). Thus our example panel of mesh electrodes would have about the same effective optical transparency of a panel made with 100 ohm ITO glass but the effective trace resistance would be many times lower that the typical 100 ohm ITO glass, which will significantly increase performance of the touch screen panel.

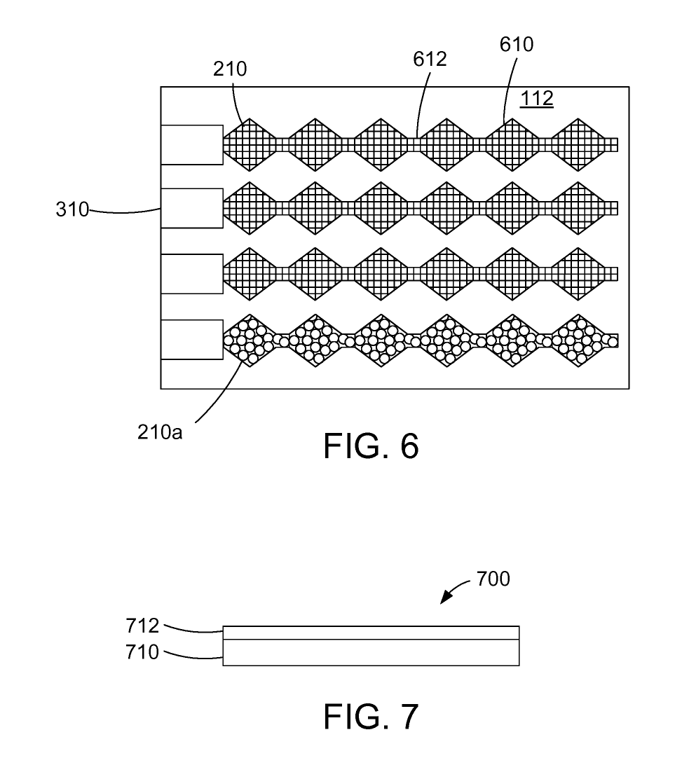

FIG. 6 illustrates another example of mesh electrodes. In this example, the mesh electrodes 210 have an outline that is a repeating pattern of diamond shapes 610. Other geometric shapes or irregular shapes could also be used together to form an electrode depending on the application. In this example, the diamond shapes 610 are connected with a narrow neck or bridge 612 and the diamonds shapes are connected together in a line to form an electrode 210. The diamond shaped mesh electrodes 210 comprise a mesh of conductors similar to that described above with reference to FIG. 3. This means that the lines of the diamond shape and the mesh of lines within the diamond shape in the drawing represent conductors and the white spaces in the drawings are open space to the glass 112 below in the manner described above. The mesh of conductors inside the diamond shape may be a pattern of squares as shown in the top three electrodes 310. Many other geometric shapes could be used to pattern the mesh of conductors inside the outline of the electrodes to reduce the visibility of the electrodes. For example, the last electrode 210a is shown with a mesh of conductors with a circle pattern 614. Similarly, other regular or irregular shapes with electrically connected conductors could be used for the mesh electrodes.

FIG. 7 illustrates a side view of a stacked layer mesh electrode 700 as described and claimed herein. In this example, a stacked layer mesh electrode 700 comprises an electrode with a base layer 710 and a stacked layer 712. The stacked layer mesh electrode 700 may comprise different layers for different reasons. For example, the base layer 710 may be a copper, nickel, or aluminum with a gold or silver stacked layer 712 to achieve a lower resistance. Alternatively, the stacked layer 712 may consist of a layer of low reflectivity material to reduce visibility of the conductive trace. The low reflectivity material would be placed on the side of the stacked electrode 700 facing the user of the touch panel. The low reflectivity material may include materials such as magnesium fluoride.

In the examples described above, the mesh electrodes were formed on a transparent layer of glass as the substrate. Touch panels substrates may also be constructed of other transparent materials such as plastic, polyester, polycarbonate and acrylic. The disclosure and claims herein expressly extend to any suitable substrate material, whether currently known or developed in the future.

In the examples described above, mesh electrodes were used for both row electrodes 116 and column electrodes 118 shown in FIG. 1. In some application it may be advantageous to only use one mesh electrode. The disclosure and claims herein apply to touch panels with a mixed construction of mesh electrodes and conventional electrodes. In a mixed construction, either the row electrode or the column electrode is a mesh electrode as described above, while the other electrode is a conventional solid electrode.

One skilled in the art will appreciate that many variations are possible within the scope of the claims. Thus, while the disclosure has been particularly shown and described above, it will be understood by those skilled in the art that these and other changes in form and details may be made therein without departing from the spirit and scope of the claims. For example, the mesh electrode described herein could be used on a touch panel configurations known in the art that use a single glass layer with patterned electrodes separated by a dielectric or on opposing sides of the glass.

1. A touch screen comprising:
a mesh electrode with a total mesh electrode area formed on a transparent layer, wherein the mesh electrode comprises electrically connecting mesh conductors formed of an opaque conductive material that covers less than 15 percent of the total mesh electrode area.

2. The touch screen of claim 1 wherein the opaque conductive material is a metal chosen from the following: nickel, copper, gold, silver, tin, aluminum and alloys and combinations of these metals.

3. The touch screen of claim 1 wherein the touch screen is a capacitive touch screen and the mesh electrodes are formed directly on a glass surface.

4. The touch screen of claim 1 wherein an outline of the mesh electrode is a repeating geometric shape.

5. The touch screen of claim 1 wherein an outline of the mesh electrode is filled with a pattern of electrically connecting mesh conductors.

6. The touch screen of claim 1 wherein the electrically connecting mesh conductors are formed in a pattern chosen from the following: rectangles, squares, circles, and irregular shapes.

7. The touch screen of claim 1 wherein the mesh conductors are formed of stacked layers of materials.

8. The touch screen of claim 1 wherein the mesh conductors are less than 0.025 mm in width.

9. The touch screen of claim 1 wherein the mesh conductors are less than 0.010 mm in width.

10. The touch screen of claim 1 wherein opaque conductive material covers less than 5 percent of the total mesh electrode area.

11. A touch screen comprising:
a first plurality of mesh electrodes formed on a first transparent layer;
a second plurality of mesh electrodes formed on a second transparent layer;
wherein the first and second plurality of mesh electrodes have a total electrode area; and
wherein the first and second plurality of mesh electrodes comprises electrically connecting mesh conductors formed of an opaque conductive material that covers less than 15 percent of the total electrode area.

12. The touch screen of claim 11 wherein the opaque conductive material is a metal chosen from the following: nickel, copper, gold, silver, tin, aluminum and alloys and combinations of these metals.

13. The touch screen of claim 11 wherein the touch screen is a capacitive touch screen and the mesh electrodes and the first and second transparent layers comprise a material chosen from glass, plastic, polyester, polycarbonate and acrylic.

14. The touch screen of claim 11 wherein an outline of the mesh electrode is a repeating geometric shape.

15. The touch screen of claim 11 wherein an outline of the mesh electrode is filled with a pattern of electrically connecting mesh conductors.

16. The touch screen of claim 11 wherein the electrically connecting mesh conductors are formed in a pattern chosen from the following: rectangles, squares, circles, and irregular shapes.

17. The touch screen of claim 11 wherein the mesh conductors are formed of stacked layers of materials.

18. The touch screen of claim 11 wherein the mesh conductors are less than 0.025 mm in width.

19. The touch screen of claim 11 wherein the mesh conductors are less than 0.010 mm in width.

20. A capacitive touch screen comprising:
a mesh electrode with a total mesh electrode area formed on a transparent layer,
wherein the mesh electrode comprises electrically connecting mesh conductors that are less than 0.01 mm in width and formed of an opaque conductive material that covers less than 5 percent of the total mesh electrode area;
wherein the opaque conductive material is a metal chosen from the following: nickel, copper, gold, silver, tin, aluminum and alloys and combinations of these metals; and
wherein an outline of the mesh electrode is filled with a pattern of electrically connecting mesh conductors formed in a pattern chosen from the following: rectangles, squares, circles, and irregular shapes.
